(19) United States
(12) Patent Application Publication
(10) Pub. No.: US 2011/0252887 A1
(43) Pub. Date: Oct. 20, 2011

(54) Electrical Damping for Isolation and Control of Mems Sensors Experiencing High-G Launch

(76) Inventor: Donato Cardarelli, Medfield, MA (US)

(21) Appl. No.: 13/087,483

(22) Filed: Apr. 15, 2011

Related U.S. Application Data
(60) Provisional application No. 61/325,048, filed on Apr. 16, 2010.

(51) Int. Cl. G01P 15/125

(52) U.S. Cl. 73/514.32

(57) ABSTRACT

A system and method for damping undesired motion of a suspended structure that is connected by one or more flexures that have an elastic limit to a fixed structure in a MEMS sensor, wherein the undesired motion is caused by a high G acceleration pulse. At one or more of before and during a high G acceleration pulse that could move the suspended structure beyond the elastic limit of a flexure, the system actively generates an attractive force that acts to counteract motion of the suspended structure caused by the high G acceleration pulse, so as to maintain motion of the suspended structure within the elastic limit of the flexure.

### CROSS-REFERENCE TO RELATED APPLICATION

This application claims priority of Provisional Patent Application Ser. No. 61/325,048 filed on Apr. 16, 2010. The contents of this Provisional Patent Application are incorporated herein by reference.

### FIELD OF THE INVENTION

This invention relates to the survivability of MEMS gyroscope and accelerometer sensors used in high-G situations such as in the gun launching of munitions and the preservation of the sensor operational properties so the sensors operate as well after launch.

### BACKGROUND OF THE INVENTION

In order for MEMS gyroscope and accelerometer sensors to guide a munition it is not sufficient for them to just survive the firing shock; the sensors must in addition be maintained in a state of low stress during the shock so that upon exiting the launch barrel, the sensors will operate as designed and tested. Usefulness upon exiting also means that the settling time for any ringing caused by residual shock input needs to be controlled.

MEMS inertial sensors are generally spring-mass devices. And they are designed for the requirements of the mission. This means that the flexures are very weak in comparison to the shock event. If the flexures are made stiffer their sensitivity is reduced. The challenge is that high precision and high shock survivability are inconsistent and at opposite ends of the spectrum.

### SUMMARY OF THE INVENTION

This invention relates to the survivability of MEMS gyroscope and accelerometer sensors used in high-G situations such as in the gun launching of munitions and the preservation of the sensor operational properties so the sensors operate as well after launch. The field is gun—hardening of inertial sensors. High-G acceleration in this case is in the form of an acceleration pulse or shock over a short period of time. The impact on the sensors is to cause excessive deflection resulting in breakage or deformation that changes sensor performance. This invention introduces an active means to minimize the sensor displacement so that the sensor structures do not exceed their elastic limit. Staying within the elastic limit is necessary to retain the operational properties of the sensors. The field is also about controlling the post-shock condition of “ringing”, which is oscillations of the sensors at the natural frequencies of its structure. Operation of the sensors requires that the settling time over which the ringing occurs is made as small as possible. The solution is to dampen the motion of the flexurally suspended structures of the sensor using electrical energy that is applied through capacitive components of the designs to create motion-controlling forces. By critically damping the motion, the ringing will not occur.

The invention allows for weak, high sensitivity MEMS gyros and accelerometers to withstand shock acceleration and retain their properties by introducing counter force pulses that support and prevent excessive displacement of the masses from their null positions. By maintaining the displacement within the elastic range of the flexure design, the sensors will retain their properties.

The first sensor example is the linear accelerometer composed of a proof mass and a set of flexures that control displacement amplitude and direction of the mass in response to acceleration input. The displacement is proportional to acceleration. The acceleration range is determined by the linearity of the pick-off and the elastic properties of the flexure. The maximum physical range is set by the gap. The flexure ruggedness and shock survivability maximum is reached for the displacement at which pick-off linearity and elasticity are met. The objective of the counter pulse force is to maintain the mass displacement below this maximum.

If properly carried out, the shock counter pulse will greatly reduce ringing by reducing the cause. Any residual ringing will be dampened with a control loop that applies counter forces at the resonant frequencies of the structure members.

The shock counter force is applied through a voltage pulse delivered to capacitive components of the accelerometer that arrest the mass motion relative to the accelerating vehicle. These capacitive components may already exist in the accelerometer for other purposes.

The second sensor example is the Coriolis gyroscope composed of at least two members. One member is used to angularly drive the total structure, which is supported above the substrate, about a Drive Axis. This member is supported with inline torsional flexures. This member is termed the Outer Member (OM). The second member, the Inner Member (IM) is supported concentrically and within the Outer Member with a set of radial flexures. The IM is the responsive member and oscillates at the same frequency as the OM with an amplitude that is proportional to rotation rate input. The gyroscope is a two mass design suspended from a fixed substrate: spring, mass, spring, mass. The flexures and masses/inertias determine the dynamics of the design. Therefore their strength and resistance to acceleration shock input is set by the gyroscope requirements and therefore are very weak in comparison. Therefore, the motion of the masses must be maintained within the elastic limit of the support flexures if the gyro is to emerge as the designed and tested unit.

The shock counter force for the sensors will be generated by discharging one or more charged capacitors across the capacitive components of the sensors resulting in a voltage pulse that will support and force the mass to follow the accelerating vehicle. A “shaped pulse” can be used to control the timing and magnitude of the counter force. A bank of charged capacitors discharged at different points of the acceleration shock pulse can be used to control a timed counter force. A set of switches caused to close by the shock pulse acceleration levels can be used to control the discharge of the capacitors.

Ringing occurs at the natural frequencies of the structure. Therefore a control loop can be used to feed back a counter force to the oscillating structure to arrest its motion. By the right choice of feedback parameters, critical damping will prevent any ringing and the settling time will be short and the operation of the sensors can begin upon exiting the fire barrel. Ringing is caused by the lack of damping in the package, which is typically vacuum-encapsulated. MEMS gyros require the vacuum to obtain high Q operation to reduce the drive voltages. Accelerometers do not require vacuum, however, and can be encapsulated with a selected gas pressure, instead. Some level of active damping may be needed and it can be controlled with an active damping loop.

The effectiveness of the electrical damping method for acceleration shock and ringing is due to the small MEMS mass and the ability to make use of existing capacitive components of the sensors to generate and apply the forces necessary in the acceleration and off-axis directions. The capacitive components can be pick-offs and actuators that are not in use until the sensor exits the launcher. Additional capacitive structures can be incorporated in the design to supplement the existing capacitive components.

The invention includes an electrical active means to apply forces to the flexurally suspended structural masses of the sensor design so as to control mass displacements so that the supporting flexures do not exceed their elastic limit and will return to their pre-shock positions. As long as the structures remain within the elastic limit, the structures won't deform and will retain their calibration characteristics.

The active means involves applying voltages to one or more capacitors of the sensor design to generate time-based forces that control the motion of the masses in a controlled way. The high-G shock input generally has a time-based shape of short duration and high amplitude. The time-based counter force should then have the form of a pulse shape. The shape and delay of the electrical pulse relative to the shock input can be engineered to “catch” the structures of the sensor as they move due to the launch force. The manner in which the counter pulse is delivered may be through capacitive discharge to build-up the voltages needed on the capacitors selected for counter forcing. A time-based method based on the release of charge from a bank of capacitors according to the throw of a set of switches can be used to shape the electrical pulse.

The time responses of the structures are oscillations related to their natural frequencies. And because MEMS sensors are generally encapsulated in a vacuum and therefore have high quality factors, Q, their settling times can be a significant portion of the mission time. Therefore there is a need to critically dampen their motion. The ringing oscillation is continuous and can be controlled by a conventional control loop. This control is discontinued once the sensor is settled. Generally, though, some level of electronic damping may be continued during operation to minimize structural motion due to vibration. Therefore the control loop for settling of ringing may utilize the control loop used for vibration damping.

The invention typically comprises one part of at least two stages of shock isolation: passive and active. Passive damping includes a shock-absorber to minimize the shock input to the sensor. If the shock were sufficiently small and the sensor mass sufficiently small, a passive means might be sufficient by itself to ensure survival, but it may not sufficiently minimize settling time. Active damping is necessary to more accurately reduce the incoming shock because it can be customized to the application and somewhat controlled. For sensitive gyros and accelerometers undergoing very high shock rates, it would require nearly complete dissipation of the input shock effect to prevent failure.

The invention can make use of existing capacitive components that serve as actuators and pick-offs for the operation of the sensors to apply active damping during the launch phase. Active shock damping is typically only used during the gun launch phase. Ringing and vibration control is continuous.

Gun launch accelerates the munition to high-G inside the barrel. The acceleration profile is a pulse shape with a narrow width and peak acceleration. The sensor within the munition will experience deflections of its structure in the opposite direction. A passive shock isolator will reduce the amplitude of the acceleration shock pulse. The active method will add greater isolation capability by applying a counter-force to the structure of the sensor to limit its deflection amplitude. The amount of deflection permitted depends on the gap between the moving structure and its corresponding substrate and the strain developed in the flexures by the deflection. The goal is for the structural member not to come into contact with the stationary part otherwise it shorts electrically. The design of the sensor will ensure that the moving member is within its elastic deflection limit at the controlled maximum deflection permitted.

The shock counter force applied to the structural members of the sensors is generated by applying a voltage to the forcer capacitors. In the active method the voltage may be a function of time so as to control the time handling of the structure and control the settling time. The voltage applied is obtained from the discharge of one or more charged capacitors. A particular source is a charged capacitor that can be discharged to build the necessary voltage on the forcing capacitor. The timing of the capacitive discharge will depend on the throw of the switch, which can be related to the shape of the passing acceleration shock pulse. The shock signal for throwing the switch may be obtainable by a high-G accelerometer. The switch would be thrown when the signal reaches a certain level. Or alternately, the switch can be designed to deflect and make electrical contact during the event.

In summary the invention includes two aspects: electrical control in response to the acceleration shock pulse and electrical control of the settling time.

### BRIEF DESCRIPTION OF THE DRAWINGS

Other objects, features and advantages will occur to those skilled in the art from the following descriptions of the preferred embodiments, and the accompanying drawings, in which:

FIG. 1 is a schematic description of a linear accelerometer configured to be damped according to the invention.

FIG. 2 is a model describing the capacitance of a comb finger pick-off with displacement of the accelerometer mass.

FIG. 3 is a model describing the capacitance change with displacement of a comb finger design with displacement of the accelerometer mass.

FIG. 4 is a model describing a typical mass response of an accelerometer when subjected to a triangular shock pulse.

FIG. 5 shows an embodiment of the capacitive discharge means for developing a counter force on the proof mass for attaining a dampened shock response.

FIG. 6 is an embodiment of a capacitive discharge means to apply a shaped counter force on the proof mass of the accelerometer.

FIGS. 7A and 7B are schematic top and side views, respectively, of a Coriolis gyroscope configured to be damped according to the invention.

FIG. 8 shows the gyro configuration of FIG. 7 in an accelerating vehicle and the implementation of the counter force.

FIG. 9 is a model describing three operating modes for the application of a counter force pulse based on the initial deflection of the mass in preparation for the acceleration shock pulse.

### DESCRIPTION OF THE PREFERRED EMBODIMENTS

### Introduction

The invention is described with respect to linear accelerometer and simple Coriolis gyro designs. However, this is not a limitation of the invention as the invention can apply to any MEMS sensor that has one or more flexurally suspended structures that need to be controlled.

### Linear Accelerometer

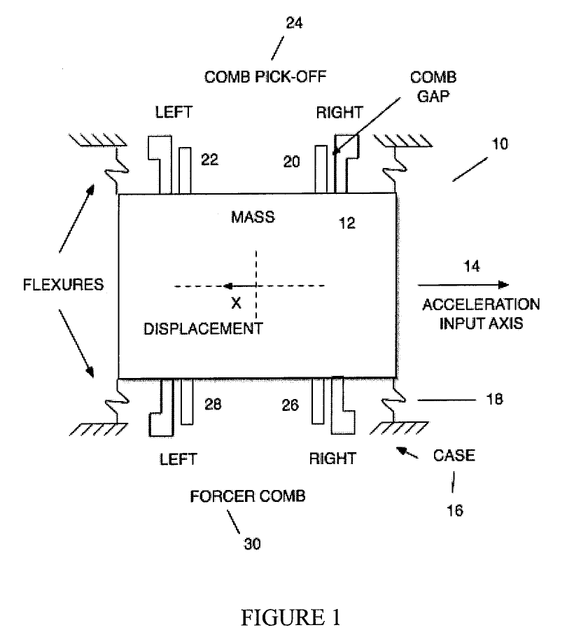

The conceptual linear accelerometer 10 is shown in FIG. 1; the design of the accelerometer per se is known in the art. It is a spring mass design comprising a mass 12 that is reactive to acceleration along an Acceleration Input Axis 14. The mass, also known as a proof mass, is flexurally attached to a fixed portion of the sensor (in this example, case 16) with four bending flexures 18 that allow displacement, X, of the mass along the Acceleration Input Axis. Note the displacement response is in the opposite direction from the acceleration input direction. A set of comb fingers comprising a Right comb finger pair 20 and a Left comb finger pair 22 makes up the pick-off comb 24 for sensing mass motion. A second set of comb fingers comprising a Right comb finger pair 26 and a Left comb finger pair 28 makes up the forcer comb 30 for applying a force to the mass. The combs are capacitive components of a type known in the field.

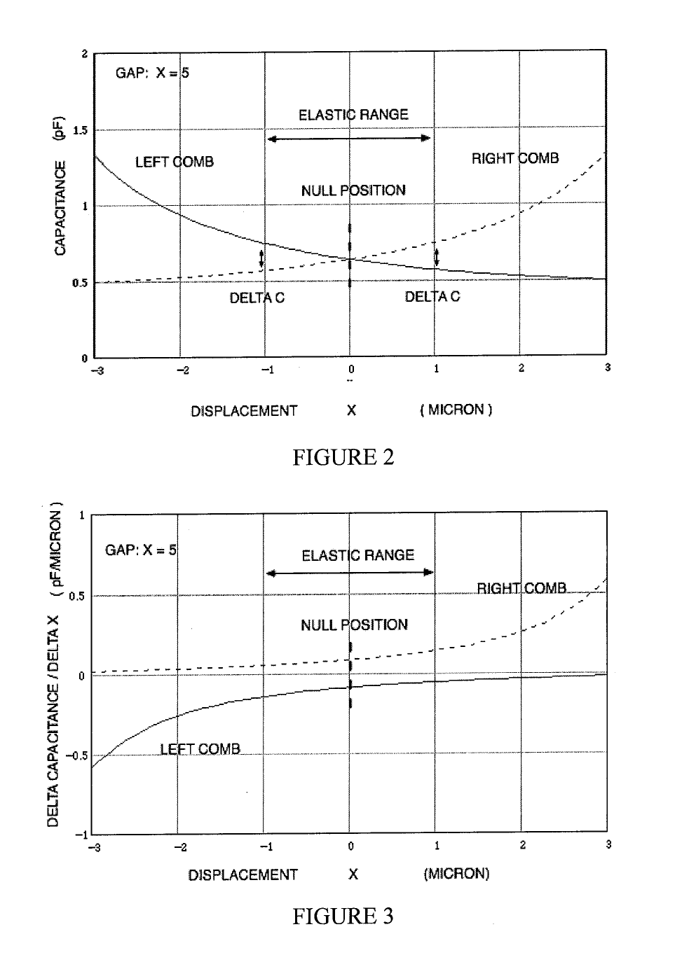

Pick-off comb 24 senses the motion of the mass as a change in capacitance of the Right and Left combs as shown in FIG. 2 for displacement+/−X values as the Right and Left gaps change. Differential operation is used to obtain the capacitance difference, DELTA C, between the two capacitance curves. This step takes out the common capacitance from the result. Note that the sign of the differential output is opposite for + and − X displacements and the displacement is proportional to DELTA C. The pick-off curves are obtained for a typical accelerometer model based on a 5 micron gap, 27 comb finger pairs for the Right and Left combs, comb length of 250 microns and comb thickness of about 40 microns.

A condition of the design is that the displacement of the mass should not exceed the elastic limit of the flexure which is indicated as X=+/−1 micron for illustration purposes. This elastic limit is certainly less than the gap of 5 microns. For a typical design and material properties, ANSYS modeling is carried out to determine the elastic limit of the flexure.

The forcer comb is an actuator used to apply a counter force to the accelerometer mass typically for maintaining the mass at X=0 with a control loop. The voltage is then proportional to the input acceleration. For the shock acceleration input, the voltage is a pulse generated by the discharge of a charged capacitor to capacitors of the device. FIG. 3 shows the modeled capability of the set of RIGHT and LEFT combs of equal design to the pick-off comb. The model calculates the change in capacitance with change in X displacement,

$$\frac{d C}{d x} ,$$

for different X values. From these the force generated is equal to

$$F = \frac{1}{2} {V}^{2} \frac{d C}{d x} ,$$

where V is the voltage applied. The voltage to be applied depends on these curves and the device capacitors selected.

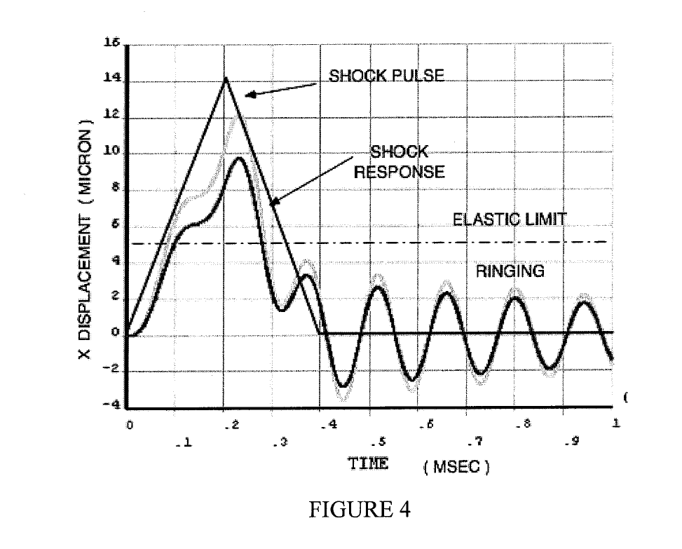

A typical modeled response is used to describe the relationship of the shock pulse applied to the mass and the response of the mass/flexure design as shown in FIG. 4. A triangular shock pulse is used for simplicity. From this model we can see the deflection of the mass over the duration of the pulse plus the ringing oscillation at the natural frequency of the spring/mass system. For the modeling, the width and amplitude of the triangle can be varied. This result was selected for illustration purposes. Also included in the figure is an elastic limit intended to demonstrate that the ringing and deflection under the pulse need to be attenuated below the line in order for the system to remain within the elastic limit.

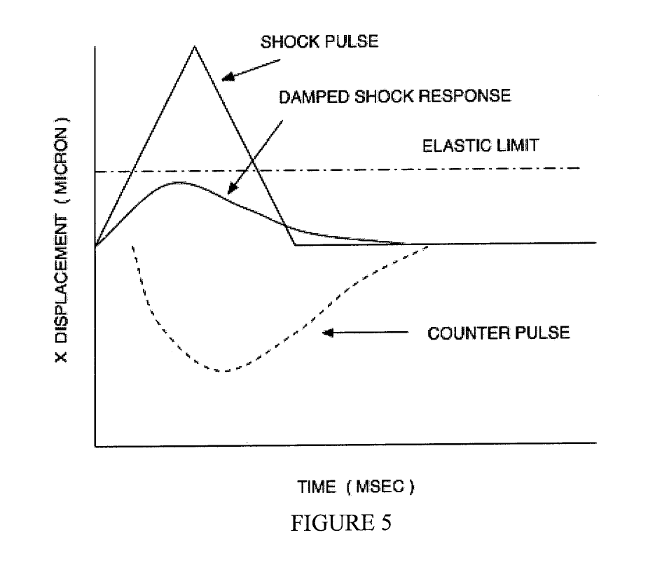

FIG. 5 is a conceptual description showing the intended damped shock response of the mass below the elastic limit as the counter force pulse is applied. The counter force pulse is applied during the shock response to force the mass to move somewhat with the vehicle so that the mass displacement does not exceed the elastic limit. In this case the counter force pulse is shown to be delayed since the capacitor discharge is initiated by the shock acceleration.

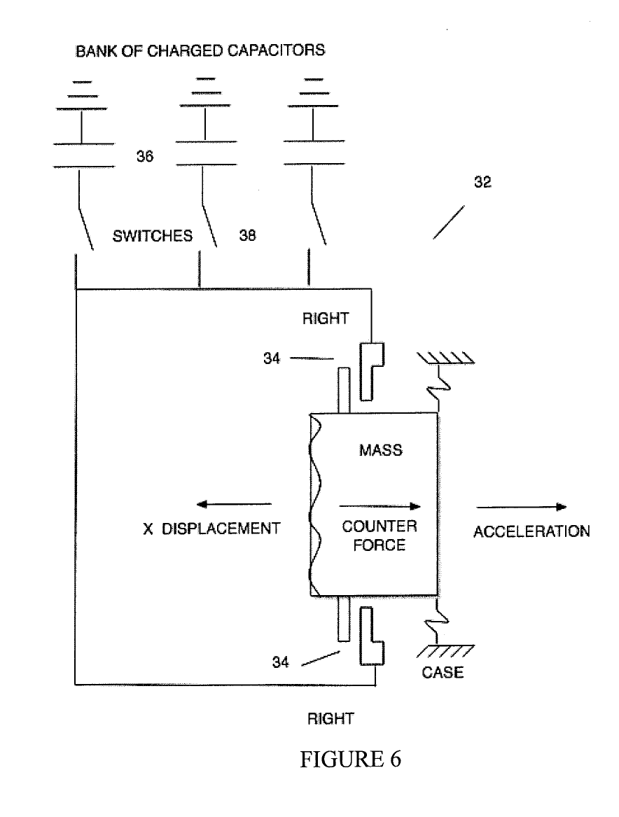

The counter pulse is generated with the system 32 shown conceptually in FIG. 6. It includes a forcer comb 34, a bank of charged capacitors 36 and a bank of switches 38. The switches are thrown at different intervals in the acceleration shock input. The switches may be cantilevers that deflect with the acceleration shock input, with each making contact at different times because of the rigidity of each cantilever design. The timing of the switches is chosen to achieve a desired result for a particular sensor.

For acceleration to the right, the mass of the accelerometer will deflect to a negative X displacement. This corresponds to a decreasing gap for the LEFT combs (not shown) and an increasing gap for the RIGHT combs. By applying the capacitive discharge voltage to the RIGHT combs a counter force to the right is applied that essentially causes the mass to follow the vehicle motion to the right.

### Coriolis Gyroscope

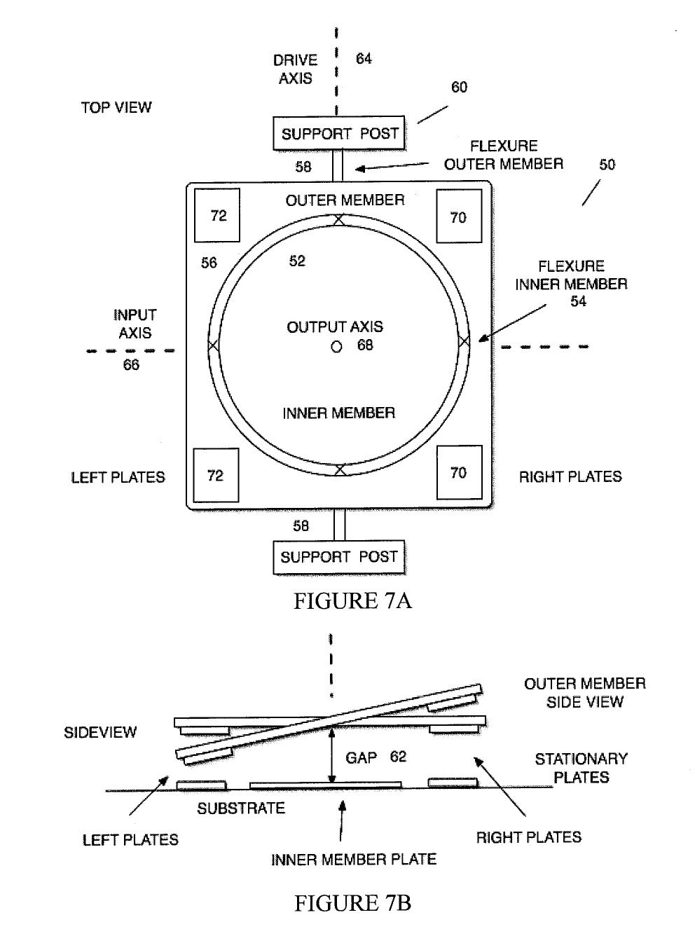

A conceptual Coriolis gyroscope 50 is shown in FIGS. 7A and 7B; the design of the gyroscope per se is known in the art. It is a spring-mass design. It comprises: Inner Member 52 (IM), which is flexurally connected with radial flexures 54 to Outer Member 56 (OM), which is flexurally connected with in-line torsional flexures 58 to support posts 60, which attach the gyro to the substrate. A gap 62 shown in the side view between the gyro structure and the substrate enables the IM and OM to move.

To operate the gyro, the OM is angularly oscillated about the Drive Axis 64. In response to input rotation rate about the Input Axis 66, the IM oscillates about the Output Axis 68 (normal to the plane). The amplitude of its oscillation is proportional to the input rotation rate. The amplitude is measured with a set of capacitive finger combs located on the IM and on the substrate (not shown). The Right 70 and Left 72 capacitive plates are used to drive the OM and to measure the amplitude of its motion. This motion is illustrated with the side view of FIG. 7B.

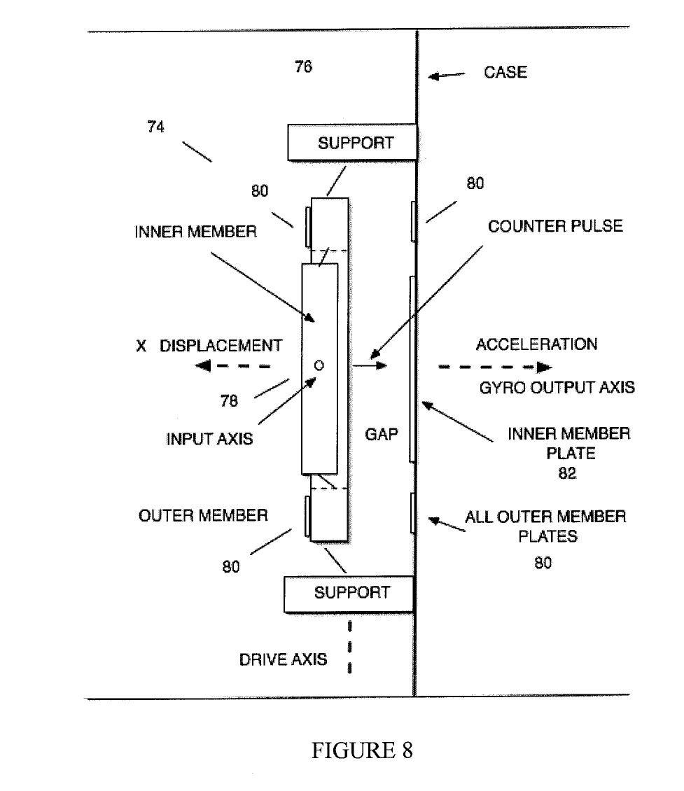

FIG. 8 is used to illustrate the alignment of the gyro 74 relative to the vehicle 76. The gyroscope Output Axis is aligned with the Acceleration Axis. This gyro senses rotation about the axis normal to the page 78. The purpose of active damping is to control the X displacement of the OM and IM due to the acceleration shock input. The IM is shown to deflect more than the OM for illustrative purposes. The counter pulse is applied in the direction of the acceleration shock pulse. All four OM plates 80 and the IM plate 82 are used to pull the OM and IM towards the substrate with counter force pulses.

### Mass in Null Position

For the discussions above, the mass is initially at its null position. The shock acceleration input moves the mass from its null position and the counter shock pulse acts to minimize the deflection by applying a force in the opposite direction. The actual motion of the mass depends on the sum of the two pulse inputs. The ideal result is for the mass to remain at its null position.

The inherent problem of capacitive forcing is that for either positive or negative applied voltages the resulting force impact is always to close the gap. In the accelerometer design the forcing voltage needs to be applied to the capacitive combs for which the gap is increasing. This unfortunately means that as the gap increases, the forcing capability decreases. Therefore it is important for the counter force pulse to be applied as soon as possible. Or to somewhat anticipate the firing shock. In this case the capacitive discharge would need to occur with or just before the firing of the gun.

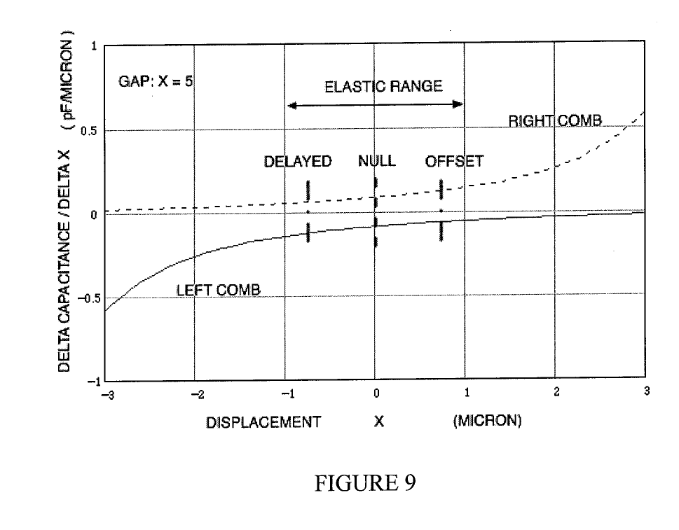

FIG. 9 is used to illustrate the effectiveness of the applied counter force relative to the dC/dX curve repeated from FIG. 3 for the accelerometer and forcing the RIGHT comb capacitors shown in FIG. 6. For the accelerometer mass initially in the null position, the forcing pulse is expected to be applied when the mass is in its delayed position. The curve for the RIGHT combs is considered and its reduced value means that the applied force is lesser than the force applicable when the mass is at its null position.

### Mass in Offset Position

For capacitive forcing, the force applied is greater for a smaller gap. Therefore to improve the counter force capability, a voltage can be applied prior to launch to pull the mass towards the expected acceleration direction thereby reducing the gap of the forcing capacitors. Upon firing, the mass accelerates in the direction opposite the acceleration shock input. By applying a counter force while the mass is offset with the small gap, the counter force will be greater. This method will require an initialization procedure whereby the operating electronics of the device applies a voltage to the RIGHT capacitors (accelerometer example of FIG. 6) to pull the mass to the right to its offset displacement as shown in FIG. 9. For the gyroscope of FIG. 8, the outer member plates and inner member plate would pull both masses to the right. In this mode the force which can be generated is greater since the dC/dX value is greater.

### Control of Ringing

The application of an ideal counter force would mean that ringing would not be caused to result. However since this is not possible, some ringing is expected. The ringing occurs at the natural frequencies of the structure. For the accelerometer with one mass, there is one natural frequency. For the gyroscope with two masses there are two natural frequencies. To counter (damp) the ringing a feedback loop applying a counter force to the appropriate capacitors of the design is applied. For the accelerometer the counter force is applied at the natural frequency. For the gyroscope two loops will be needed to arrest the separate ringing motions.

### Summary

The invention involves a system and method that adds active capability to the isolation of sensors from shock and aids the control of ringing for a fast settling time. The active method involves the direct forcing of the susceptible structures of the sensors to maintain their displacement within their elastic limit so that the sensors operate with the same characteristics after the event. Active control is achieved electrically by applying a voltage to a capacitive structure such as a comb or plate to pull the moving structure in the desired direction. The forcing shape will be a pulse that can be engineered to arrest the motion of the mass and transition to the control of the settling time using a ringing feedback control loop that depends on the signals from the sensor pick-offs. The settling time effectiveness is in part a function of the electrical shock control method. The active damping method is dependent on the sensor design and the level of passive damping. Although the method is based on an electrical capacitor, magnetic means can also be applied based on coils and eddy currents. The discharge from a capacitor source is used in order to obtain a controlling pulse on the moving mass that is as fast as the shock pulse. The counter force pulse and its execution has to be predetermined for the application since it would be impractical to actually sense the motion and direct the counter force in the required time. The ringing can be sensed and controlled with conventional feedback loops.

What is claimed is:

1. A system for damping undesired motion of a suspended structure that is connected by one or more flexures to a fixed structure in a MEMS sensor, wherein the undesired motion is caused by a high G acceleration pulse, the system comprising:
a capacitive forcer that is adapted to apply capacitive force to the suspended structure; and
a control system that reacts to the high G acceleration pulse and in response provides a voltage to the forcer, to cause the forcer to apply a force to the suspended structure that decreases motion of the suspended structure caused by the high G acceleration pulse.

2. The system of claim 1 wherein the control system comprises one or more switches.

3. The system of claim 2 wherein each switch comprises a movable member that is moved by the high G acceleration pulse.

4. The system of claim 3 wherein the control system further comprises one or more storage capacitors, wherein there is a switch between each storage capacitor and the capacitive forcer.

5. The system of claim 4 wherein the control system provides voltage from a storage capacitor to the capacitive forcer when a switch closes as a result of a high G acceleration pulse.

6. The system of claim 5 comprising a plurality of storage capacitors and an equal plurality of switches.

7. The system of claim 6 wherein different switches are adapted to close at different amplitudes of the acceleration pulse.

8. The system of claim 1 wherein the MEMS sensor comprises an accelerometer and the capacitive forcer comprises a comb that defines a gap that varies dependent on acceleration.

9. The system of claim 1 wherein the MEMS sensor comprises a gyroscope comprising an inner member that is flexurally connected to an outer member that surrounds the inner member, wherein the capacitive forcer comprises a plurality of capacitive plates located on a fixed structure that is spaced from the inner and outer members, wherein the capacitive plates are arranged and adapted to generate an attractive force that pulls on the inner and outer members.

10. A method for damping undesired motion of a suspended structure that is connected by one or more flexures that have an elastic limit to a fixed structure in a MEMS sensor, wherein the undesired motion is caused by a high G acceleration pulse, the method comprising:
at one or more of before and during a high G acceleration pulse that could move the suspended structure beyond the elastic limit of a flexure, actively generating an attractive force that acts to counteract motion of the suspended structure caused by the high G acceleration pulse, so as to maintain motion of the suspended structure within the elastic limit of the flexure.

11. The method of claim 10 wherein actively generating force comprises providing a capacitive forcer that is adapted to apply capacitive force to the suspended structure.

12. The method of claim 11 wherein actively generating force further comprises providing a voltage to the capacitive forcer.

13. The method of claim 12 wherein voltage is provided to the forcer at least after the initiation of the high G acceleration pulse to the sensor, to cause the forcer to apply a force to the suspended structure that decreases motion of the suspended structure caused by the high G acceleration pulse.

14. The method of claim 13 wherein the voltage is provided by one or more storage capacitors.

15. The method of claim 14 wherein the voltage is further provided via one or more switches, wherein there is a switch between each storage capacitor and the capacitive forcer.

16. The method of claim 15 wherein each switch comprises a movable member that is moved by the high G acceleration pulse.

17. The method of claim 16 wherein voltage is provided from a storage capacitor to the capacitive forcer when a switch closes as a result of a high G acceleration pulse.

18. The method of claim 17 comprising a plurality of storage capacitors and an equal plurality of switches.

19. The method of claim 18 wherein different switches are adapted to close at different amplitudes of the acceleration pulse.

20. The method of claim 11 wherein the MEMS sensor comprises an accelerometer and the capacitive forcer comprises a comb that defines a gap that varies dependent on acceleration.

21. The method of claim 11 wherein the MEMS sensor comprises a gyroscope comprising an inner member that is flexurally connected to an outer member that surrounds the inner member, wherein the capacitive forcer comprises a plurality of capacitive plates located on a fixed structure that is spaced from the inner and outer members, wherein the capacitive plates are arranged and adapted to generate an attractive force that pulls on the inner and outer members.

22. The method of claim 12 wherein voltage is provided to the capacitive forcer before the initiation of the high G acceleration pulse to the sensor, to cause the forcer to apply a force to the suspended structure that moves the suspended structure in a direction opposite to the direction it moves as a result of the high G acceleration pulse.

23. The method of claim 10 further comprising controlling ringing after the high G acceleration pulse using at least one feedback loop that applies an attractive force that damps ringing.

24. The method of claim 23 wherein ringing is controlled using one feedback loop for each suspended structure.
